(19) United States
(12) Patent Application Publication
(10) Pub. No.: US 2006/0165065 A1
(43) Pub. Date: Jul. 27, 2006

(54) Communications address provisioning system and method therefor

(76) Inventor: Marc Jeffrey Lawrence-Apfelbaum, New York, NY (US)

Correspondence Address: ROBERTS ABOKHAIR & MARDULA, SUITE 1000, 11800 SUNRISE VALLEY DRIVE, RESTON, VA, 20191, US

(21) Appl. No.: 11/263,694

(22) Filed: Nov. 1, 2005

Related U.S. Application Data
(60) Provisional application No. 60/624,933, filed on Nov. 4, 2004.

(51) Int. Cl. H04L 12/66

(52) U.S. Cl. 370/352

(57) ABSTRACT

A system and method for provisioning a communication address. A query server comprises a record of a sought party that associates a communications address with at least one other communications address. The record optionally comprises a set of permissions that establishes conditions under which a communications address may be disclosed to a seeking party. A query client provides a seeking party an interface to send a query to the query server comprising a known communications address of the sought party and to request disclosure of other communications addresses of the sought party. The query client additionally provides the seeking party an interface to convey permission information necessary to satisfy the conditions for release established by the sought party. The query client is adapted to invoke an application (for example, an e-mail client or a VoIP dialer) suited to a selected communications address disclosed by the query server. The query server may also provide proxy services to permit a seeking party to communicate with a sought party without disclosure of the sought party's communications addresses.

### CROSS REFERENCE TO RELATED APPLICATIONS

This application claims priority under 35 U.S.C. § 119(e) from provisional application No. 60/624,933 filed Nov. 4, 2004. The 60/624,933 provisional application is incorporated by reference herein, in its entirety, for all purposes.

### BACKGROUND

The present invention relates generally to associating communications addresses with known addresses.

The Internet has become a critical communication tool for both business and non-business users. Billions of emails are sent every day. One e-mail address directory touted that it contained over four hundred million unique addresses.

Recently, the potential of the Internet for carrying voice communications has been realized. For most of the last century, telephone communications were exclusively handled through circuit switched networks (generically identified as the public switched telephone network or “PSTN”). Circuit switching establishes a connection between a calling party and a called party. If all goes well, the circuit is maintained until the call terminates.

The Internet is a packet-switched network. Unlike the public switched telephone network (PSTN), the Internet does not rely on switched circuits but uses network addressing protocols and packets to establish and maintain communications between points on the network.

With the development of packet switching and the growth of the Internet, voice communication using packet switching technology has become an attractive alternative to the PSTN. Referred to as voice over Internet Protocol or “VoIP,” the technology to make packet-based voice services is evolving rapidly. Providers of broadband services (e.g., cable service providers), local phone companies, Internet service providers (ISPs), and independent service companies (among others) are offering telephone services that can manage calls that originate and terminate on packet switched networks while also allowing VoIP calls to be terminated on, or initiated from, the PSTN.

The Internet is a challenging environment in which to emulate a circuit. Systems and protocols have been developed to solve some of these problems, most notably the Session Initiation Protocol (SIP) and the companion protocol, the Session Description Protocol (SDP). SIP is an application layer signaling protocol that defines initiation, modification and termination of interactive, multimedia communication sessions between users. FIG. 1 illustrates the components of a SIP framework. The SIP framework comprises a user agent 100. User agent 100 may act as a user agent client (not separately illustrated) or a user agent server (not separately illustrated), a proxy server 115, a location server 120, redirect server 125, and a registrar server 130.

A user agent 100 is an application that initiates, receives and terminates calls. A user agent 100 initiates a call and a user agent acting as a user agent server receives a call. Both a user agent client and a user agent server can end a call.

Proxy Server 115 is an intermediary program that acts as both a server and a client to make requests on behalf of other clients. Requests are serviced internally or by passing them on, possibly after translation, to other servers. The proxy server 115 may interpret, rewrite or translate a request message before forwarding it. A proxy server 115 is not required within a SIP framework. If the proxy server is not used, the SIP client 100 communicates directly with the redirect server 125.

A location server 120 is used by SIP to redirect a proxy server to obtain information about a called party's possible location(s). A redirect server 125 accepts a SIP request, maps the address into zero or more new addresses. If a proxy server 115 is used, the address or addresses are returned to the proxy server 115. If no proxy server is used, the redirect server 125 returns these addresses to the user agent 100. Unlike a proxy server 120, the redirect server 125 does not initiate a SIP request. Unlike a user agent server 110, the redirect server 125 does not accept or terminate calls.

Registration server 130 accepts register requests. The registration server may also support authentication. A registration server is typically co-located with a proxy or redirect server and may offer location services.

In order to facilitate SIP exchanges, a SIP client typically registers with a SIP registration server. Registration can also occur when the SIP user client needs to inform the SIP/registration server of its location. The registration information is periodically refreshed and each user client must re-register with the SIP registration server. The SIP registration server will forward this information to be saved in the location server. A registration message conveys the information needed to register the client with the SIP registration server.

While SIP is not the only vehicle used to facilitate a telephone call over an IP network, the implementation of SIP as described above illustrates the complexity of establishing a session over an IP network. Additionally, even though it is possible for two parties to establish a voice session over an IP network, most VoIP sessions will involve the facilities of a third party service provider (TPSP). A TPSP manages a private network to provide on-network voice services, manages an interface to the public switched telephone network (PSTN) to allow off-network calls, and manages a telephone numbering system to provide subscribers with unique telephone numbers.

In cable networks, cable service providers provide VoIP service over a private IP network, not the Internet. Cable service providers that implement industry standards established for high-speed data services and multimedia services may interconnect their systems to create larger packet only-systems.

Technology has thus made it possible to establish a communication path between two parties using various media. Keeping track of the e-mail addresses and telephone numbers of friends and associates can be a daunting task. One approach is to create a directory-based service that mimics Domain Name Servers (DNS). Using a known unique telephone number, a directory server creates a pointer to where user information can be found. If the number is dialed via an enterprise system, the directory server can return a user preference of the dialed party to the enterprise system. The enterprise system can then establish a communication path via the dialed party's stated preference.

While this approach helps locate a party with a known telephone number, it does little to assist a caller who has only the e-mail address of the desired call recipient. What would be desirable is a system and method for associating a party's e-mail address(es) with that party's other communication addresses (PSTN telephone number(s), VoIP telephone number(s), fax number(s), other e-mail address(es)) and establishing permissions dictating the conditions under which a communication address may be disclosed. Using such a system and method, a seeking party with knowledge of an e-mail address of a sought party could acquire knowledge of other communications addresses of the sought party subject to permissions established by the sought party.

### SUMMARY

An embodiment of the present invention provides a system and method for associating a party's e-mail with that party's other communication addresses (PSTN telephone number(s), VoIP telephone number(s), fax number(s), other e-mail address(es)) and establishing permissions dictating the conditions under which a communication address may be disclosed. A query server comprises a record of a sought party that associates at least one e-mail address with one telephone number. The record optionally further comprises a set of permissions that establishes conditions under which a communications address may be disclosed to a seeking party. A query client provides the seeking party an interface to send a query to the query server comprising a known e-mail address of the sought party and to request disclosure of other communications addresses of the sought party that are associated with the known communications address. The query client additionally provides the seeking party an interface to convey permission information necessary to satisfy the conditions for release established by the sought party. In another embodiment of the present invention, the query client is adapted to invoke an application (for example, an e-mail client or a VoIP dialer) suited to a selected communications address disclosed by the query server.

It is therefore an aspect of the present invention to use a known e-mail address to obtain other communications addresses associated with a sought party.

It is another aspect of the present invention to allow a sought party to establish permissions dictating the conditions under which a communications address of the sought party may be disclosed.

It is still another aspect of the present invention to allow a seeking party to establish a VoIP-based call to a sought party when the seeking party knows the sought party's e-mail address.

It is yet another aspect of the present invention to notify a sought party that a query for a communication address has been received from a seeking party lacking the requisite permissions for disclosure and providing the sought party an opportunity to authorize disclosure of the communication addresses to the seeking party.

It is another aspect of the present invention to establish communications between a seeking party and a sought party via a proxy without disclosing a communication address of the sought party.

These and other aspects of the present invention will become apparent from a review of the general and detailed descriptions that follow.

In an embodiment of the present invention, a calling party uses a software module (a “query client”) to query a query server for a communications address of a sought party using a known e-mail address of the sought party. The query server parses the e-mail address and determines whether the sought party is registered with the query server. A sought party may be registered with the query server under a variety of circumstances. By way of illustration and not as a limitation, an e-mail service provider with whom the sought party has an account may operate the query server. Alternatively, the query server may be operated as a directory service independent of other services to which the sought party may have subscribed.

If the sought party is not registered with the query server, the query server will respond to the query that the sought party is unknown to the query server. Alternatively, the query server may forward the query to other query servers. In yet another alternative embodiment, the query server may send e-mail to the sought party using the e-mail address provided by the seeking party inviting the sought party to register with the query server.

If the sought party is registered with the query server, the query server then determines the conditions for disclosure established by the sought party and whether the seeking party meets the conditions for disclosure of one or more communications addresses. In this regard, the query server may respond to the seeking party with a request for an authorization code or other indicia of permission from the sought party to receive the communications address. If the seeking party meets the conditions for disclosure, the query server discloses communications addresses in accordance with the preferences of the sought party.

In an alternate embodiment of the present invention, a sought party may establish a proxy relationship with the query server. In this embodiment, the proxy store communicates with both parties without disclosing a communications address of the sought party.

### SUMMARY OF THE DRAWINGS

FIG. 1 illustrates the components of a SIP framework as known in the prior art.

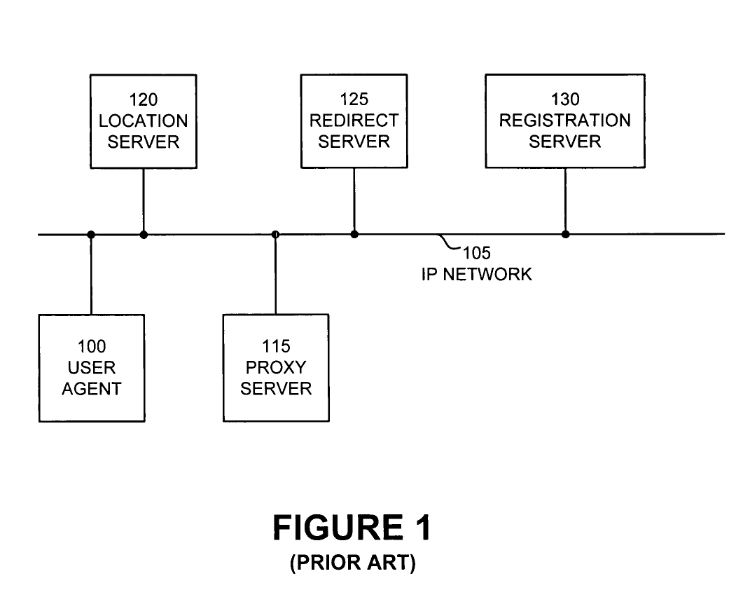

FIG. 2 illustrates the logical components of a communications address provisioning system according to embodiments of the present invention.

FIG. 3 illustrates a message flow and logic of a communications address provisioning system according to embodiments of the present invention.

### DETAILED DESCRIPTION

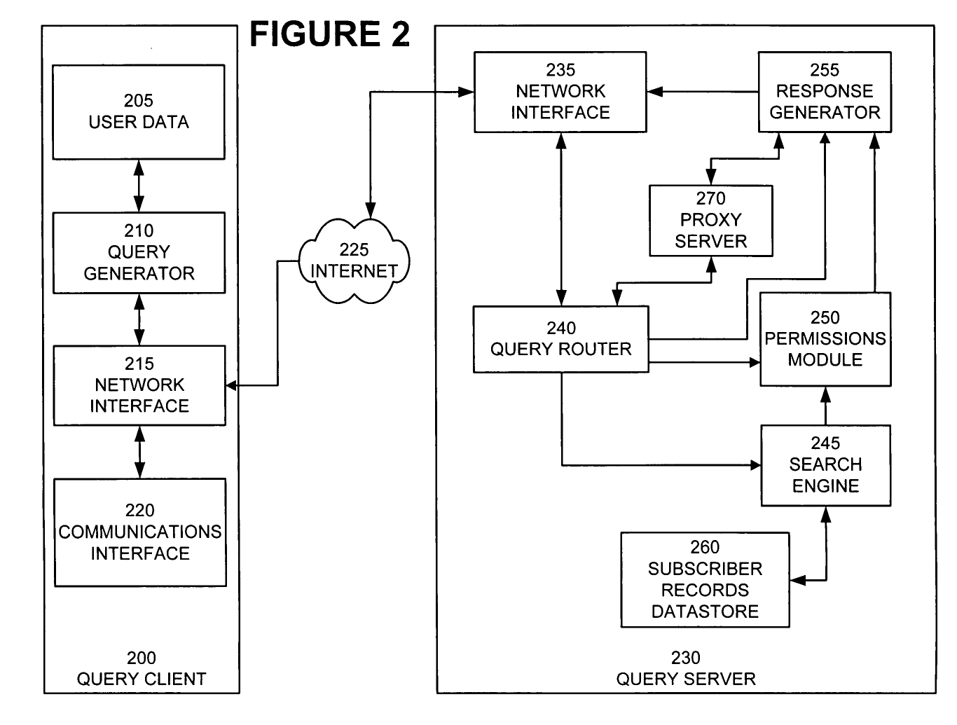

FIG. 2 illustrates the logical components of a communications address provisioning system according to embodiments of the present invention. Query client 200 comprises user data 205, a query generator 210, a network interface 215, and a communications interface 220.

Query generator 210 reads input from a user interface (not shown) to construct a query comprising a known e-mail address of a sought party. Query generator may access user data 205 to provide authentication information to query server 230 or to convey permissions information to permissions module 250. Query client 200 communicates with query server 230 over the Internet 225 and via network interface 215 and network interface 235.

Query server 230 comprises network interface 235, query router 240, search engine 245, permissions module 250, response generator 255, subscriber record 260, and proxy server 270. A query message is received at network interface 235 and passed to query router 240. The query router 240 determines the nature of the query message and routes it accordingly. By way of illustration and not as a limitation, a query message may be an inquiry or it may be a response to a message from response generator 255. Response generator 255 creates messages that provide information to the query client 200, messages that request information from query client 200, and messages that are conveyed via proxy server to establish blind communications between a seeking party and a sought party.

Queries requesting a communications address of a sought party are parsed by the query router 240 for the known communications address representing the search string and directed to the search engine 245. Search engine 245 searches subscriber records datastore 260 to determine whether a record matching the search string is stored there. When matches are found, permissions module 250 is consulted to determine the conditions that must be satisfied by the seeking party to obtain a communications address stored in subscriber records datastore 260. If the query included user data, that data is checked to determine whether the permissions have been satisfied.

As noted, response generator 255 prepares a response to query client 200 appropriate to the last query message and to the results of related query messages. Thus, if a query requesting a communications address is successful and all permissions are met, the response message will convey the communications address or addresses of the sought party. If additional information is required to perform a search or to determine if the seeking party has the requisite permissions to receive communications addresses of the sought party, the response message will request additional information. In an embodiment of the present invention, messages generated by response generator 255 are encoded to facilitate routing of responses from query client 200 by query router 240.

In an embodiment of the present invention, when a query for a communications address results in a match, but the seeking party does not meet the permissions established by the sought party for release, response generator 255 issues a response message to the query client 200 indicating that communications addresses are available but that the information cannot be provided to the seeking party. Optionally, the response message in this instance may offer to have the query server 230 contact the sought party for authorization to release the communications address to the seeking party. In yet another embodiment of the present invention, a sought party may instruct the query server 230 to notify the sought party of queries for a communications address. The notification may be established for all queries or only those queries for which the established permissions have not been met.

In an alternative embodiment of the present invention, if no match is found, the response generator 255 uses the search string to provide the sought party an invitation to register with the query server 230. The response generator 255 may defer sending a “no-match” message to query client 200 for a fixed period of time to allow the sought party time to respond to the invitation.

In yet another embodiment of the present invention, proxy server 270 bridges communications between a seeking party and a sought party. In this embodiment, proxy server 270 uses a communications address of a sought party is to forward electronic communications from a seeking party to a sought party. By way of illustration and not as a limitation, the communication may be an e-mail or a VoIP call. In the latter case, the VoIP call is received by the query client through communications interface 220. In still another embodiment of the present invention, a query server 200 uses a telephone bridge (not illustrated) to connect both parties via the public switched telephone network (PSTN).

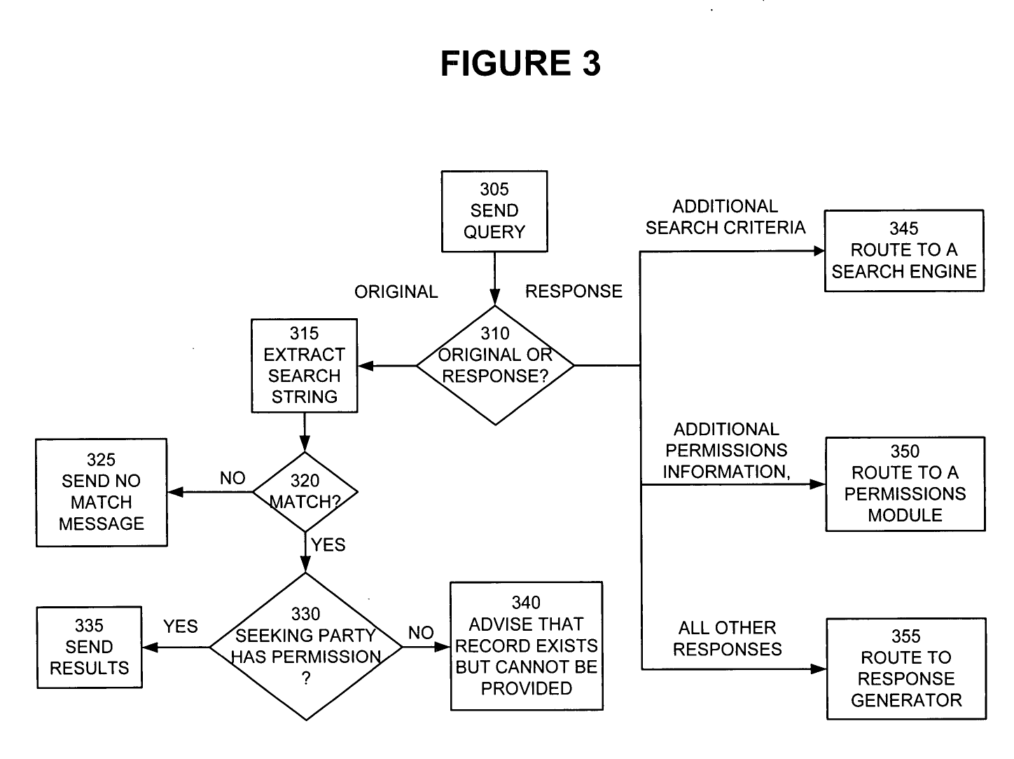

FIG. 3 illustrates a message flow and logic of a communications address provisioning system according to embodiments of the present invention. Referring to FIG. 3, a communications address query is generated and sent to a query server 305. The query is evaluated to determine whether it is an original message or a response message 310. If the query is an original message, a search string is extracted 315. A determination is made whether a record matching the search string is stored in a subscriber records datastore 320. If no match is found, a message is returned to the sender that no communications addresses matching the search criteria were found 325.

In an alternative embodiment of the present invention, if no match is found, the query server uses the search string to provide the sought party an invitation to register with the query server. The query server may defer sending a “no-match” message to the seeking party for a fixed period of time to allow the sought party time to respond to the invitation.

If a match is found, a determination is made whether the seeking party has permission to receive the matched results 330. If the seeking party has the requisite permissions, the matched results are provided to the seeking party 335. If the seeking party does not have requisite permissions, the seeking party is notified that communications addresses have been found but cannot be provided 340. In this instance, the seeking party may contact the sought party by a known means and acquire permission from the sought party. Alternatively, the seeking party may request that the communications address provision system request permission from the sought party to release the communications addresses to the seeking party.

If the query message is a response message, the response message is routed according to the response expected by the communications address provisioning system. If the response is to provide additional search criteria, the response is routed to a search engine 345. If the response is to provide additional permissions information, the response is routed to a permissions module 350. All other responses are routed to the response generator for evaluation and further response if required 355.

A communications address provisioning system has been described. It will be understood by those skilled in the art that the present invention may be embodied in other specific forms without departing from the scope of the invention disclosed and that the examples and embodiments described herein are in all respects illustrative and not restrictive. Those skilled in the art of the present invention will recognize that other embodiments using the concepts described herein are also possible. Further, any reference to claim elements in the singular, for example, using the articles “a,” “an,” or “the” is not to be construed as limiting the element to the singular.

What is claimed is:

1. A communications address provisioning system comprising:
a query client adapted to communicate with a query server, wherein the query client comprises a query generator for generating a query from a seeking party and wherein the query comprises a known communications address of a sought party:
the query server comprising:
a query router adapted to parse the query for the known communications address of a sought party;
a search engine adapted to determine if an additional communications address of the sought party is associated with the known communications address;
a permissions module, adapted to determine whether the seeking party has permission to receive the additional communications address; and
a response generator, adapted to generate and send a message directed to the seeking party comprising:
if no additional communications address of the sought party is associated with the known communications address, notification that an additional communications address was not found; and
if an additional communications address of the sought party is associated with the known communications address but the seeking party does not have permission to receive the additional communications address, notification that the additional communications address was found but cannot be provided; and
if an additional communications address of the sought party is associated with the known communications address and the seeking party has permission to receive it, notification of the additional communications address.

2. The system of claim 1, wherein the known communications address is selected from the group consisting of an e-mail address, a telephone number, an instant message address, and a voice over IP SIP address.

3. The system of claim 1, wherein the additional communications address is selected from the group consisting of an e-mail address, a telephone number, an instant message address, and a voice over IP SIP address.

4. The system of claim 1, wherein the response generator is further adapted to generate a request message comprising a request for additional information and wherein the query router is adapted to route a response message from the seeking party to the information request message according to the additional information provided in the response message.

5. The system of claim 1, wherein the response generator is further adapted to generate a request message comprising a request for additional information and a message identifier and wherein the query router is adapted to route a response message from the seeking party to the information request message according to the message identifier.

6. The system of claim 1, wherein the response generator is further adapted to, if an additional communications address of the sought party is associated with the known communications address but the seeking party does not have permission to receive the additional communications address, generate and send a request message directed to the sought party comprising a request for permission to provide the seeking party the additional communications address.

7. The system of claim 1, wherein the response generator is further adapted to generate and send an invitation message directed to the sought party comprising an invitation to associate additional communications addresses of the sought party with the known communications address, if no additional communications address of the sought party is associated with the known communications address.

8. The system of claim 1, wherein the query server further comprises a proxy server adapted to bridge communications between a seeking party and a sought party and wherein the response generator is further adapted to if an additional communications address of the sought party is associated with the known communications address but the seeking party does not have permission to receive the additional communications address, generate and send a message directed to the sought party comprising a request for permission to proxy communications between the seeking party and the sought party.

9. The system of claim 1, wherein the query client comprises a communications interface adapted to initiate communications using the additional communications address.

10. The system of claim 9, wherein the additional communications address is selected from the group consisting of an e-mail address, a telephone number, an instant message address, and a voice over IP SIP address.

11. A method for provisioning a communication address comprising:
generating a query from a seeking party, wherein the query comprises a known communications address of a sought party;
receiving the query at a query server and parsing the query for the known communications address;
searching a database to determine if an additional communications address of the sought party is associated with the known communications address;
if no an additional communications address of the sought party is associated with the known communications address, then notifying the seeking party that an additional communications address was not found;
if an additional communications address of the sought party is associated with the known communications address, then determining whether the seeking party has permission to receive the additional communications address;
if the seeking party has permission, then notifying the seeking party of the additional communication address; and
if the seeking party does not have permission, then notifying the seeking party that the additional address was found but cannot be provided.

12. The method for provisioning a communication address of claim 11, wherein the known communications address is selected from the group consisting of an e-mail address, a telephone number, an instant message address, and a voice over IP SIP address.

13. The method for provisioning a communication address of claim 11, wherein the additional communications address is selected from the group consisting of an e-mail address, a telephone number, an instant message address, and a voice over IP SIP address.

14. The method for provisioning a communication address of claim 11, further comprising, then generating and sending an invitation message directed to the sought party comprising an invitation to associate additional communications addresses of the sought party with the known communications address if no additional communications address of the sought party is associated with the known communications address.
